(19) United States
(12) Patent Application Publication
(10) Pub. No.: US 2008/0228747 A1
(43) Pub. Date: Sep. 18, 2008

(54) INFORMATION SYSTEM PROVIDING ACADEMIC PERFORMANCE INDICATORS BY LIFESTYLE SEGMENTATION PROFILE AND RELATED METHODS

(76) Inventors: Grant I. Thrall, Gainesville, FL (US); M. Harry Daniels, Gainesville, FL (US)

Correspondence Address: STEPHEN H. LUTHER;ALLEN, DYER, DOPPEIT, MILBRATH & GILCHRIST, P.A., 255 S. ORANGE AVENUE, SUITE 1401, P.O. BOX 3791, ORLANDO, FL, 32802-3791, US

(21) Appl. No.: 11/687,273

(22) Filed: Mar. 16, 2007

(51) Int. Cl. G06F 17/30

(52) U.S. Cl. 707/5

(57) ABSTRACT

An information processing method may include providing past academic performance data for at least one student associated with at least one lifestyle segmentation profile (LSP). The past academic performance data may include academic test score data, for example. The method may further included generating an academic performance indicator for the LSP based upon the past academic performance data.

### FIELD OF THE INVENTION

The present invention generally relates to information systems.

### BACKGROUND OF THE INVENTION

Student achievement tests have become commonplace within the United States and other nations. Such tests are used to both evaluate the student and the school. Variations in performance have been attributed to quality of school.

Testing has been a hallmark of education in America for more than 150 years, and standardized tests have been used to assess student performance for nearly a century. From its earliest beginnings, standardized testing has been employed for a variety of purposes, including the following: to promote school reform, to assess student learning, to determine the effectiveness and influence of teaching and curriculum, and to ensure that all students have access to the same educational opportunities. The current practice of high-stakes testing is not a new phenomenon; rather, it represents the latest version of an accepted approach for monitoring academic achievement.

Although a variety of methods have been employed by educators to monitor academic achievement, the developers of standardized tests have emphasized either norm-referenced or criterion-referenced measures. Before turning to the differences that distinguish the two forms, it will be helpful to consider three important similarities. First, all standardized tests are designed to measure the degree to which a student has learned a predefined body of knowledge. The domain of knowledge is defined by two primary factors: curriculum and grade level. Taken together, these factors allow test developers to build instruments that provide valid and reliable estimates of the degree to which students at each grade level can perform a variety of educational tasks that have been derived from the curriculum. Typically, separate subtests are developed for specific curricular topics. Precise guidelines for constructing standardized educational tests have been developed by the American Educational Research Association (AREA) and the American Psychological Association (APA). Second, standardized tests are administered according to a strict protocol, which ensures that all test takers complete the test in a uniform manner, that is, in a predetermined order and within specified time limits. Third, the responses of all test takers are evaluated against the same scoring key.

The critical difference between norm-referenced and criterion-referenced tests is determined by the users' purposes. If the purpose of the test is to determine whether students have mastered a prescribed body of knowledge, users would elect to use a criterion-referenced instrument. Stakeholders who have an interest in determining whether students can meet predetermined performance standards identify the content domain of criterion-referenced tests, and then develop test items that are directly related to content of the curriculum. Student performance on such a test is determined by a single measure, typically presented in standard score units, for each subtest. By comparing a student's score with the identified criterion, it is possible to determine whether the observed score falls above or below the criterion.

In the case of norm-referenced tests, performance is determined by comparing each student's observed score with the scores reported for an appropriate norm group. That is, a norm-referenced test allows stakeholders to determine how an individual student is doing in comparison with others in a particular norm group. The critical issue in interpreting student performance is to select an appropriate norm group. Testing companies respond to this problem by providing a wide variety of normative data, including norms that are tied to national, state, and regional norms, as well as norms that are linked to school size, location, and student composition. The availability of this array of normative data is meant to insure the ecological validity of the test.

The general public perception is that variation in student's performance on tests such as the Florida Comprehensive Assessment Test (FCAT) is determined primarily, if not exclusively, by the quality of teaching provided by the school. Legislation is pending in Florida to reward schools that achieve high FCAT scores, and penalize schools with low FCAT scores. The rationale is that teachers educate the students and that the unbiased measure of how well teachers perform their task is the average FCAT score.

The professional educational literature too supports that it is the teacher that educates and prepares students for their achievement scores. Teachers collectively make up a school, and the average performance of students in the school is a measure of the average performance of the teachers within the school. Better teachers, and better qualified teachers are assigned to better schools, and teachers that are less proficient at educating or less qualified are assigned schools that are considered to be performing at lower levels within the system of schools.

In an area of development separated from the above education testing and tracking of test results, geographic information systems (GIS) were being developed. An important feature of these systems is the lifestyle segmentation profile (LSP). LSPs are also known as psychographics. LSPs are often comprised of credit score indexes, summarizing a households propensity to consume, financial ability to consume, and general lifestyle such as retired or college student.

LSP indexes are created by collecting spatially referenced data on consumers, constructing statistical models of identity, and mapping distributions of consumer characteristics or types as discussed in an article by Jon Goss entitled “We Know Who You Are and We Know Where You Live: The Instrumental Rationality of Geodemographic Systems” Economic Geography, Vol. 71, No. 2 (April, 1995), pp. 171-198, and in an article by Grant Thrall entitled “ESRI's Community Coder: A Tapestry of LSPs” GeoSpatial Solutions, vol. 14, No. 3 (March, 2004), pp. 46-49, both of which are incorporated herein in their entireties by reference. Large electronic data bases are created comprised of both public and private information sources. These databases generally include information on consumer location (a spatial code) and consumption patterns. Geographic Information Systems (GIS) are used to spatially analyze and visually represent the populations' spatial distribution of consumer characteristics. LSPs can be created with the use of statistical procedures, including factor analysis, cluster analysis, and other correlation procedures.

The LSP index is based on several assumptions as discussed in the Goss article referenced above. First, that social identity can be reduced to measurable characteristics and that the population can be classified into a small number of coherent and stable segmentation categories. Second, once an LSP index is assigned to an individual or population, it can be predictive of behavior. Third, that residential location is either highly correlated to or a determinant of social identity and behavior.

Marketing and the maintenance of consumer databases date to the nineteenth century. Systematic customer segmentation and “micro-marketing” was deployed in the 1950s and practiced on a large scale in the 1970s. Today, the use of psychographic/LSP indexes is standard operating procedure in market analysis and retail location evaluation as discussed in the above noted Thrall article, and in his book Business Geography and New Real Estate Market Analysis (2002, Oxford University Press, Oxford and New York), which is incorporated herein in its entirety by reference. Today, private geospatial technology vendors sell data sets of psychographic scores at various geographic scales including US Postal ZIP+4, five digit ZIP code, census tract, and other geographic scales globally. Commonly deployed LSP datasets used today to profile customers include Psyte® from MapInfo®, Community Tapestry™ from ESRI®, Experian®, and Prizm® from Claritas/NDS®. Commercial LSP databases are chosen on the basis of expediency.

Data that are used to calculate LSP indexes often come from credit bureaus such as TransUnion®, Equifax® and Experian®, as well as credit card expenditure information. Essentially, LSPs are assigned to households according to their demonstrated expenditure patterns. Since the data is reported at the geographic scale of the ZIP+4, the dominant LSP index can be assigned to the ZIP+4. A typical suburban ZIP+4 may typically include houses on one side of a street along a full or partial block. Large buildings, including apartment buildings, can have multiple ZIP+4. ESRI's® Community Tapestry segmentation system partitions U.S. residential areas into 65 segments based on demographic variables such as age, income, home value, occupation, household type, education, and other consumer characteristics. A commentary on LSP, Tapestry™ and geocoding is provided in the above cited article and book by Thrall, and in Grant Thrall “Geocoding Made Easy’ GeoSpatial Solutions, vol. 16, no. 3 (March, 2006), p. 46-49, which is incorporated herein in its entirety by reference.

Despite the existence of academic testing data, on the one hand, and GIS applications with LSPs on the other, in some application it may be desirable to utilize the analytical abilities of GIS applications to help evaluate academic data.

### SUMMARY OF THE INVENTION

In view of the foregoing background, it is therefore an object of the present invention to provide an information processing method that may include providing past academic performance data for at least one student associated with at least one lifestyle segmentation profile (LSP), where the past academic performance data includes academic test score data, and generating an academic performance indicator for the at least one LSP based upon the past academic performance data.

If at least one unprofiled student that does not have an associated LSP is present, an LSP for the unprofiled student may be determined based upon past academic performance data for the at least one unprofiled student, the past academic performance data for the at least one student, and the at least one LSP associated with the at least one student. Additionally, academic performance indicators for the at least one unprofiled student may be determined based upon past academic performance data for the at least one unprofiled student and the past academic performance data for the at least one student.

In some embodiments, the at least one student may be considered at least one first student. Moreover, if at least one second student with missing past academic performance data is present, academic performance indicators for the at least one second student may be determined based upon an LSP associated with the at least one second student, the at least one LSP associated with the at least one first student who has past academic performance data, and the academic performance indicator for the at least one first student. Where LSPs have insignificant statistical differences, the LSPs may be grouped together for ease of data review, reporting or other purposes.

Additionally, the past academic performance data may be standardized test score data, student attendance rate data, student truancy data, student tardiness data and/or other past academic performance data. The academic performance indicator may be generated based upon an average of past academic performance data, and that average may be a mean average or other average, for example.

An information system is also provided which may include a database for storing past academic performance data for at least one student associated with at Least one LSP, where the past academic performance data comprises academic test score data. The information system may further include a processor cooperating with the database for generating an academic performance indicator for the at least one LSP based upon the past academic performance data.

Yet another aspect is directed to a computer-readable medium having computer-executable instructions for causing a computer to perform steps which may include providing past academic performance data for at Least one student associated with at least one LSP, where the past academic performance data includes academic test score data. Another step may include generating an academic performance indicator for the at least one LSP based upon the past academic performance data.

### BRIEF DESCRIPTION OF THE DRAWINGS

FIG. 1 is a perspective view of an information system of the present invention.

FIG. 2 is a flow diagram illustrating a method for generating academic performance indicators for geographic locations according to the present invention.

FIG. 3 is a flow diagram illustrating a method for generating academic performance indicators for geographic locations illustrating processing for neighboring geographic locations according to the present invention.

FIG. 4 is a flow diagram illustrating a method for generating academic performance indicators for geographic locations and for grouping geographic locations with insignificant statistical differences in academic performance indicators according to the present invention.

FIG. 5 is a table of a local master file for use in the system of FIG. 1.

FIG. 6 is a table of the local solutions file for use in the system of FIG. 1.

FIG. 7 is a table of the Wide Area Summary File for use in the system of FIG. 1.

FIG. 8 is a table showing the average FCAT by LifeMode group for use in the system of FIG. 1.

FIGS. 9A and 9B are tables showing a chart of average FCAT scores for use in the system of FIG. 1.

FIG. 10 is a table showing a comparison of mean differences for FCAT reading scores by LSP for use in the system of FIG. 1.

FIG. 11 is a table showing a comparison of mean differences for FCAT math scores by LSP for use in the system of FIG. 1.

FIG. 12 is a table showing a SAPI reduction algorithmic procedure for math and reading scores for use in the system of FIG. 1.

FIG. 13 is a table showing a projection of a student's expected test score based upon address for use in the system of FIG. 1.

FIG. 14 is a collection of tables showing the connection between the Local Master File and the National Master File, and possible file layouts of each for use in the system of FIG. 1.

FIG. 15A is a schematic diagram of a local and master file configuration for use in the system of FIG. 1, and FIG. 15B is a corresponding database table layout therefor.

FIGS. 16A through 16D are graphs of Alachua County data for reading and mathematics for use in the system of FIG. 1.

FIG. 17 is a graph of the relationship between different LSPs by SAPI.

FIG. 18 is a flow diagram illustrating a method for determining academic performance indicators for LSPs according to present invention.

FIG. 19 is a flow diagram illustrating a method for determining LSP or academic performance indicators for geographic locations or unprofiled students according to the present invention,

FIG. 20 is a flow diagram illustrating a method for determining academic performance indicators where past academic performance data is missing according to the present invention.

### DETAILED DESCRIPTION OF THE PREFERRED EMBODIMENTS

The present description is made with reference to the accompanying drawings, in which preferred embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation is used to indicate similar elements in alternative embodiments.

Applicants theorize based upon case study data that will be discussed further below that the home social-economic status of students (e.g., K-12 students) is a significant, if not the dominant, determinant of academic performance, and that student lifestyle segmentation profiles (LSPs) are accurate indicators for determining variation in educational achievement and performance.

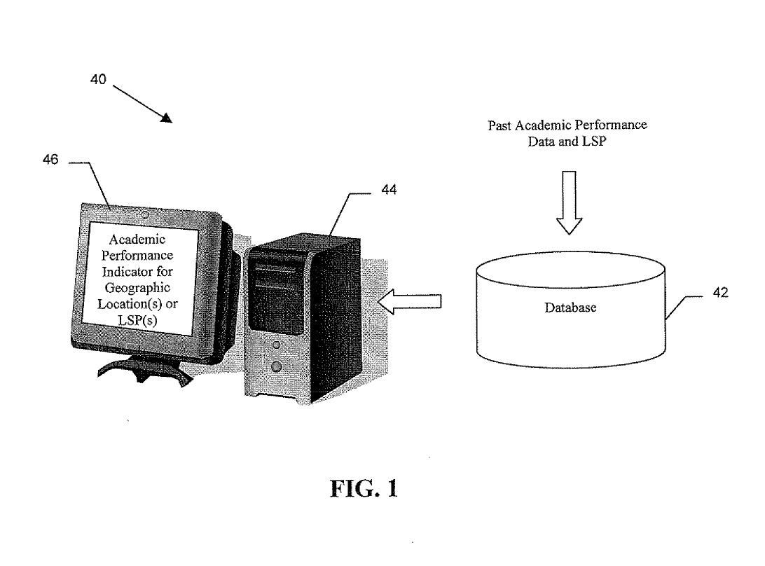

With reference to FIG. 1, a system 40 for use in generating academic performance indicators for geographic locations, LSPs or students illustratively includes a database 42 for storing information related to academic performance for students residing in one or more geographic locations and LSPs associated with the locations) the system 40 also illustratively includes a processor 44 cooperating with the database 42 for generating an academic performance indicator for the at least one geographic location based upon the past academic performance data and the LSP. The academic performance indicators and other related information may be presented to the user through a display device 46 of FIG. 1.

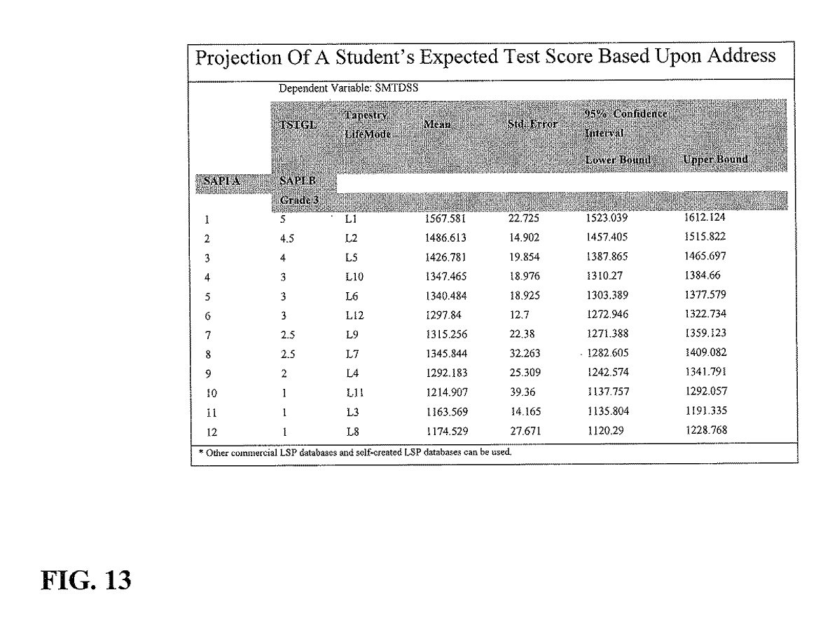

The academic performance indicator is used to predict academic achievement or performance and may be associated with students, geographic locations or LSPs. One exemplary academic performance indicator is the Scholastic Attainment/Performance Index (SAPI) that will be discussed further below. The academic performance indicator may be a single number or a group of numbers. An example of an academic performance indicator as a group of numbers is provided in the range of expected SCAT performance shown in the graph at FIG. 13.

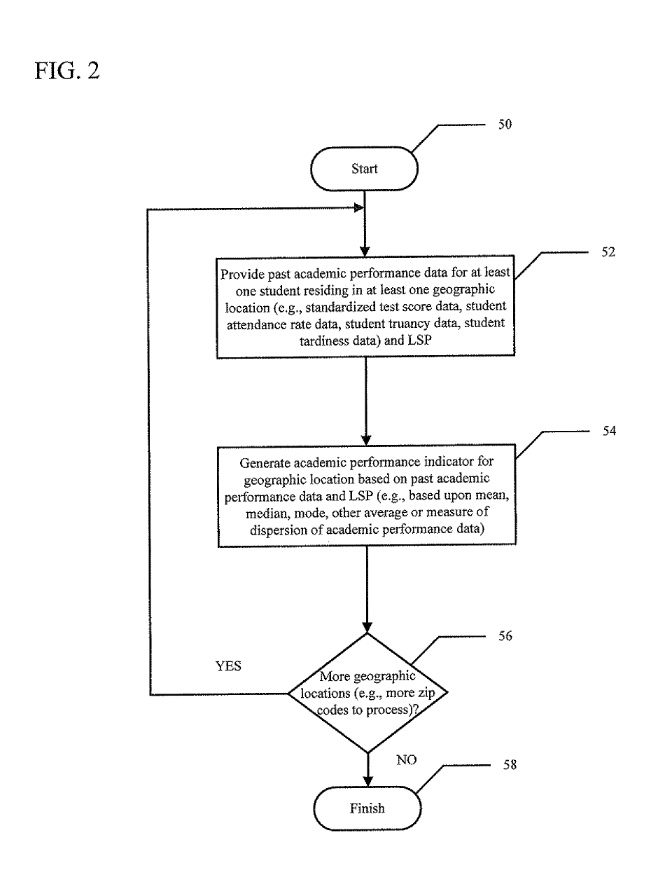

As shown in FIG. 2, a method for geographic information processing begins at the start 50. The method illustratively includes providing past academic performance data for at least one student residing in at least one geographic location having an LSP associated therewith, Block 52. By way of example, the past academic performance data may include standardized test scores, student attendance rate data, student truancy data or student tardiness data. The method may further include generating an academic performance indicator for the at least one geographic location based upon the past academic performance data and the LSP (Block 54). As will be discussed further below, the academic performance indicator may be based upon an average of the past academic performance data for the geographic location such as a mean, although other averages such as the median or mode may be appropriate for other embodiments. If there is more than one geographic location to process (Block 56), the above-noted steps are repeated for the additional locations. If not, the method terminates, Block 58.

In some embodiments of the invention, it may be desirable to assign academic performance indicators to neighboring geographic locations. This embodiment may be used where no data exists for the neighboring geographic location or where data is incorrect or incomplete for the neighboring geographic location. Missing or incorrect data is not required to perform the method of assigning academic performance indicators to neighboring geographic locations.

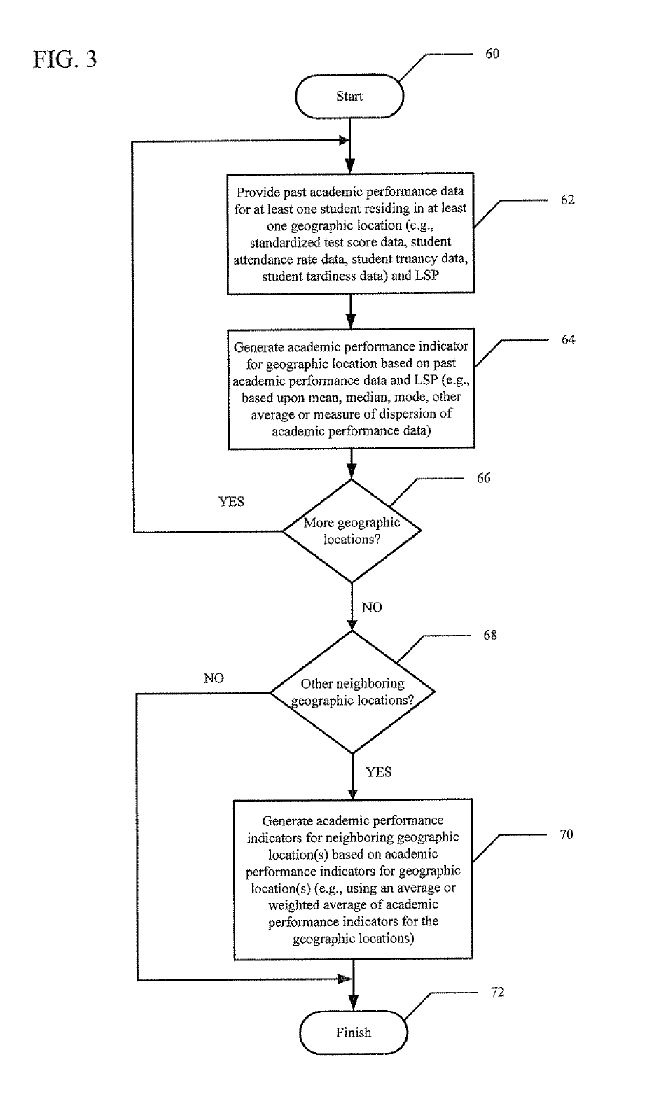

With reference to FIG. 3, the method generally involves beginning at start (Block 60), providing past academic performance data for at least one student residing in at least one geographic location having an LSP associated therewith (Block 62), generating an academic performance indicator for the at least one geographic location based upon the past academic performance data and the LSP (Block 64), and then determining if there are more geographic locations to process (Block 66). If there are more locations to process, the method is performed again from the first step. If not, then at Block 68 a query determines if there are neighboring geographic locations for which academic performance indicators should be assigned. If there are no neighboring geographic locations to process, the method terminates at the finish (Block 72). If there are neighboring geographic locations to process, the method then generates an academic performance indicator for a neighboring geographic location adjacent to the at least one geographic location based upon the academic performance data for the at least one geographic location and the LSP (Block 70). The data used to generate academic performance indicators for these neighboring geographic locations may be the academic performance indicator assigned to the adjacent geographic location or it may be the past academic performance data and LSP for the adjacent geographic location.

The adjacent geographic locations used for generating the academic performance indicator may be determined using a weighted average of adjacent locations where spatially closer locations have a greater influence on the academic performance indicator assigned to the neighbor than do geographically more distant locations as shown at Block 70.

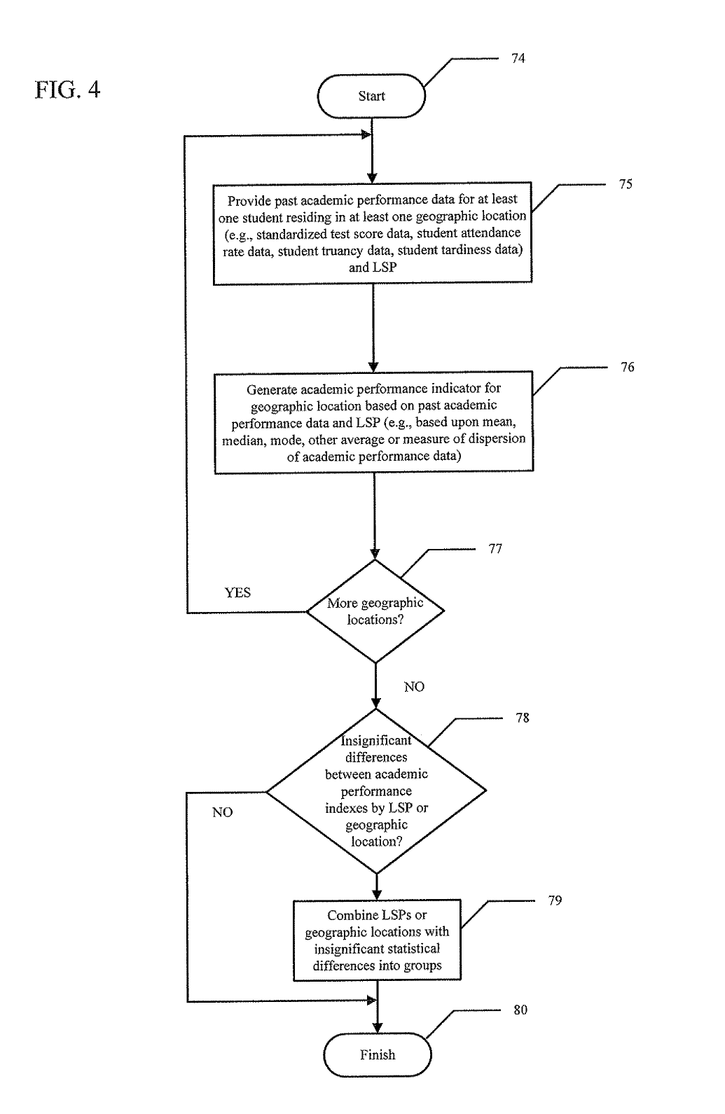

As shown in FIG. 4, a further embodiment of the present invention may be used to group geographic locations together where the academic performance indicators for those locations do not show statistically significant differences. The method generally begins at the start (Block 74), proceeds to providing past academic performance data for at least one student residing in at least one geographic location having an LSP associated therewith (Block 75), and then generating an academic performance indicator for the at least one geographic location based upon the past academic performance data and the LSP (Block 76). A query determines if there are more geographic locations to process (Block 77). If there are more geographic locations to process, the method returns to the beginning. If not, then the geographic locations are examined to determine if there are insignificant statistical differences between the academic performance indicators by LSP (Block 78). If all geographic locations have statistically significant differences, the process terminates at the end (Block 80). If LSPs or geographic locations are present that have insignificant statistical differences, those LSPs or geographic locations may be combined into a single group (Block 79).

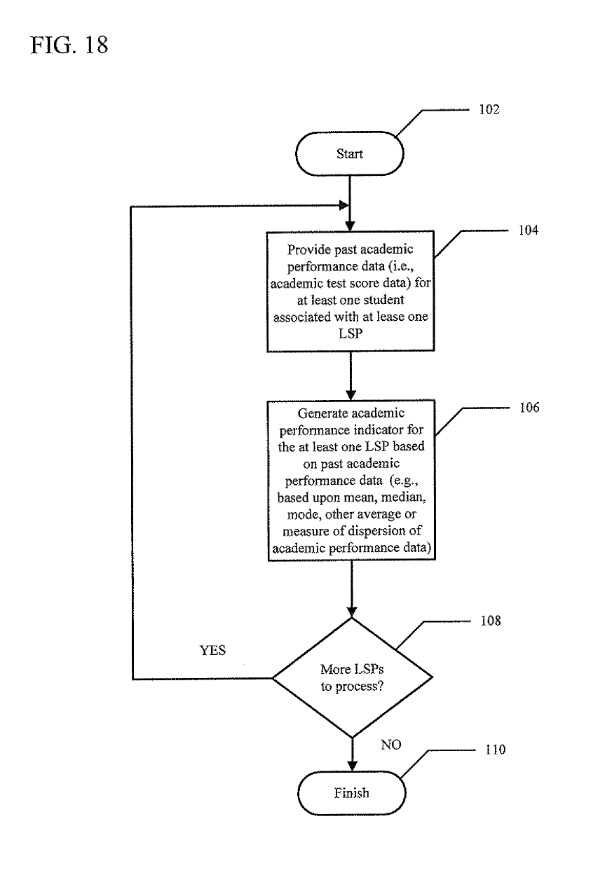

Academic performance indexes may also be assigned without reference to geographic locations. With reference to FIG. 18, a geographic information processing method begins at the start (Block 102). The method then illustratively proceeds to providing past academic performance data for at least one student associated with an LSP, where the past academic performance data includes academic test score data (Block 104). This information is then used to generate an academic performance indicator for the LSP based upon the past academic performance data (Block 106). If there are no more LSPs to process (Block 108), the method terminates (Block 110). If there are more LSPs to process, the method begins over again at the beginning.

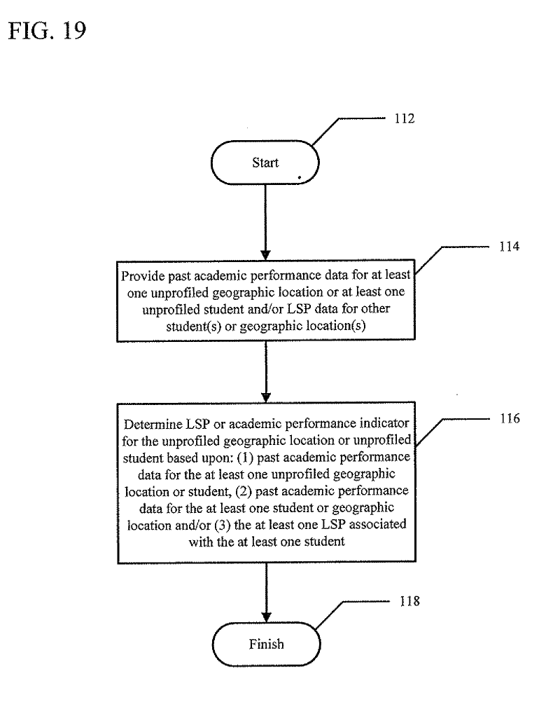

There are often situations where one or more items of desired data are not found in the database or databases that are used to generate academic performance indicators. Where items of desired data are not present, a number of fallback procedures may be used to either provide the desired data or determine academic performance indicators without the data. One such situation occurs with unprofiled geographic locations or unprofiled students (i.e., geographic locations or students that do not have an associated LSP). With reference to FIG. 19, the present invention provides a method to determine LSPs for unprofiled geographic locations or unprofiled students. The method illustratively begins at start 112 and then provides past academic performance data for the at least one unprofiled student or unprofiled geographic location and the past academic performance data for the at least one student or at least one geographic location and may also involve providing LSP data for student(s) or geographic locations) (Block 114). This data is then used to determine LSP or academic performance indicator for the unprofiled geographic location or unprofiled student based upon past academic performance data for the at least one unprofiled geographic location or student, past academic performance data for the at least one student or geographic location and/or the LSP associated with the at least one student (Block 116). The process may then be repeated for other unprofiled students or unprofiled geographic locations as desired until the end (Block 118).

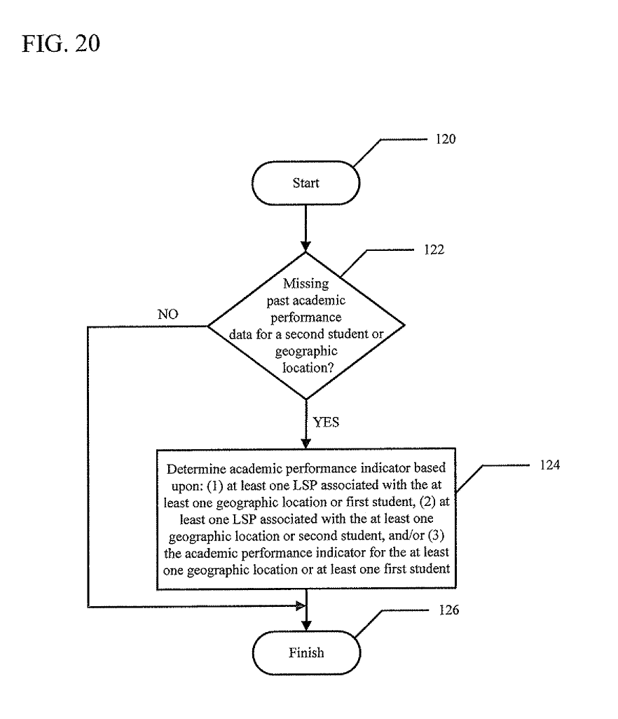

In other situations, past academic performance data for at least one student or at least one geographic location may be missing. With reference to FIG. 20, the method illustratively begins at start 120 and proceeds to determine if past academic performance data is missing for a second student (i.e. a second student that does not have past academic performance data in contrast to a first student that does have past academic performance data) or geographic location (Block 122). If no past academic performance data is missing, then the method may terminate (Block 126) or may proceed to the methods disclosed in FIGS. 2, 3, 4, 18 or 19. If past academic performance data is missing, an academic performance indicator may be determined based upon an LSP associated with the at least one geographic location or first student, the LSP of the at least one geographic location or second student, and/or the academic performance indicator for the geographic location or at least one first student (Block 124).

The various embodiments of the invention shown in FIGS. 2, 3, 4, 18, 19 and 20 may be utilized independently or in combination. For example, academic performance indicators may be assigned to neighboring geographic locations as described with reference to FIG. 3, and then geographic locations or LSPs with insignificant statistical differences may be grouped together as described with reference to FIG. 4. Other combinations of the methods disclosed in these figures may be utilized as will be appreciated by those skilled in the art.

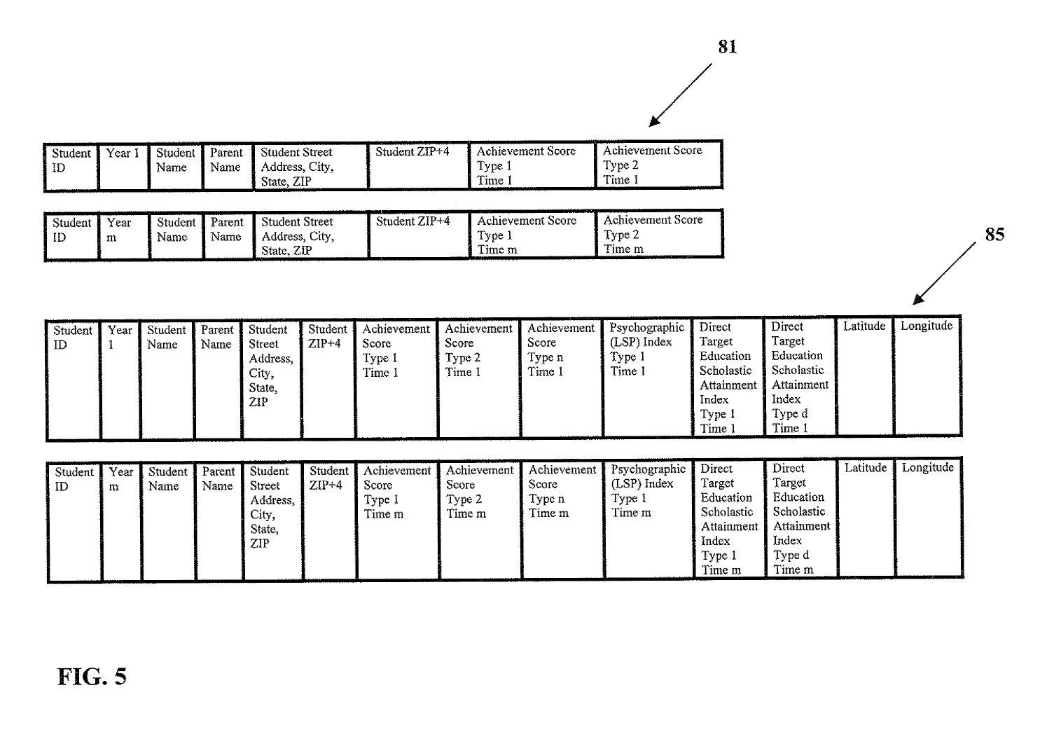

A Local Master File 85 in its original and preprocessed form is created and can be maintained by the school board or other organization as shown in FIG. 5. The local student file 81 contains records for students, the historical record of their performance on scholastic achievement and advancement assessment tests and their address. In one embodiment, the Local Student File 81 is processed to create the Local Master File 85. The processing includes geocoding the records to add latitude longitude coordinates based upon the U.S. Postal address of the students' home to student records.

Geocoding is the GIS process of assigning geographic coordinates to a map object, such as a point associated with a street address. Street address geocoding software will calculate the geographic coordinate (latitude, longitude) of the address. As a fallback procedure, if the address cannot be geocoded, the geocoding software may calculate the ZIP+4 of the street address and assign the geographic coordinate of the ZIP+4. Since psychographic measurements are often available at the ZIP+4 geographic scale, geocoding software might also use relational database management (RDBM) to assign psychographic indexes to addresses at the ZIP+4 geographic scale. The geocoded data record, including the psychographic measurement and any student academic achievement scores, can then be mapped and further spatially analyzed.

Community Coder™ from ESRI® is one of several commercial geocoding software products that also assigns LSP indexes to each data record. Community Coder™ assigns ESRI's® Tapestry™ LSP indexes. Given a street address such as 2605 NW 38^{th} St., Gainesville Fla. 32605, Community Coder™ will calculate latitude-longitude geographic coordinates, and add these geographic coordinates to the data record. In the process of geocoding, the ZIP+4 for the address is also calculated. The Community Coder™ software product uses relational database management to assign Tapestry™ LSP indexes to each data record based upon its ZIP+4 code. Other types of databases may also, however, be used.

Geocoding may be very valuable for generating reports using the present invention, particularly where those reports display information graphically on a map. However, geocoding need not necessarily be used in all embodiments.

Students will typically be geocoded to their street address or their ZIP+4 code. Each student in the database may have a spatial code, such as a ZIP+4 code. The processing will also include the assignment of a measure of LSP. The LSP measure can be licensed and purchased as part of a software and data package from a commercial vendor, or constructed independent of, and without assistance from, a commercial vendor using procedures known in the industry. Likewise, the assignment of latitude longitude coordinates can be executed by way of commercial vendor software and data packages, or by using automated procedures known in the industry. The addition of some or all of the above information results in the creation of the Local Master File 85.

Commercial data vendors may choose to license the procedure used to create the local Master File 85 and include it as an add-on to their product so that the academic performance indicators are available to customers of the data vendor(s).

The steps for creating and updating the Local Master File 85 may be performed as follows. Scholastic attainment records for students are normally updated one time each year, following completion of the scholastic attainment examinations. Student records are also typically kept in electronic format. Therefore, updating the Local Master File 85 can be an automated process preferably triggered when the new data becomes available. School districts willing to participate by providing the necessary student record data can, as an incentive to do so, be provided automated reports to improve their education services.

Commercial vendor software packages and data may be utilized with the present invention. Examples of commercial vendor software and data are ESRI's® Community Coder™, which assigns latitude longitude coordinates based upon best of street address or ZIP+4 code, it also assigns ZIP+4 code, and assigns indexes of LSPs known as Tapestry MapInfo® provides a similar product known as PSYTE®, as does NDS Claritas® with its PRIZM®, and Experian® with its product.

The preprocessed local master file 85 may then be statistically evaluated. This statistical evaluation can be executed in an automated manner, or by using commands in standard statistical (i.e., SPSS), geostatistical (e.g., Geographically Weighted Regression by Fotheringham and Point Pattern Analysis by Getis), Countour Density Mapping (e.g., Surfer® by Golden Software™), GIS (e.g., ESRI®, MapInfo®, Caliper®), database (e.g., Microsoft Access®) or spreadsheet software (e.g., Microsoft Excel®),

The criteria and mathematically-based geospatial reduction procedure can be applied to the Local Master File 85 to group geographic locations or LSPs together. In one embodiment, the Local Master File 85 is accessed by the procedure and averages of student educational attainment and assessment scores categorized by LSP groups are calculated. The LSP groups are ranked according to performance (e.g., from highest to lowest). Statistical tests such as Tukey's Honestly Significant Difference test are executed to evaluate the statistical significance (or lack thereof) of the grouped measurements. Where no statistically significant differences exist, the LSPs may be grouped together.

The averages of student educational attainment are preferably the mean average. However, the median, mode or other averages and measures of dispersion may also be used. In some circumstances a mode average is preferable to a mean average where a cluster of data would cause the mean average to be either too low or too high to accurately reflect educational attainment.

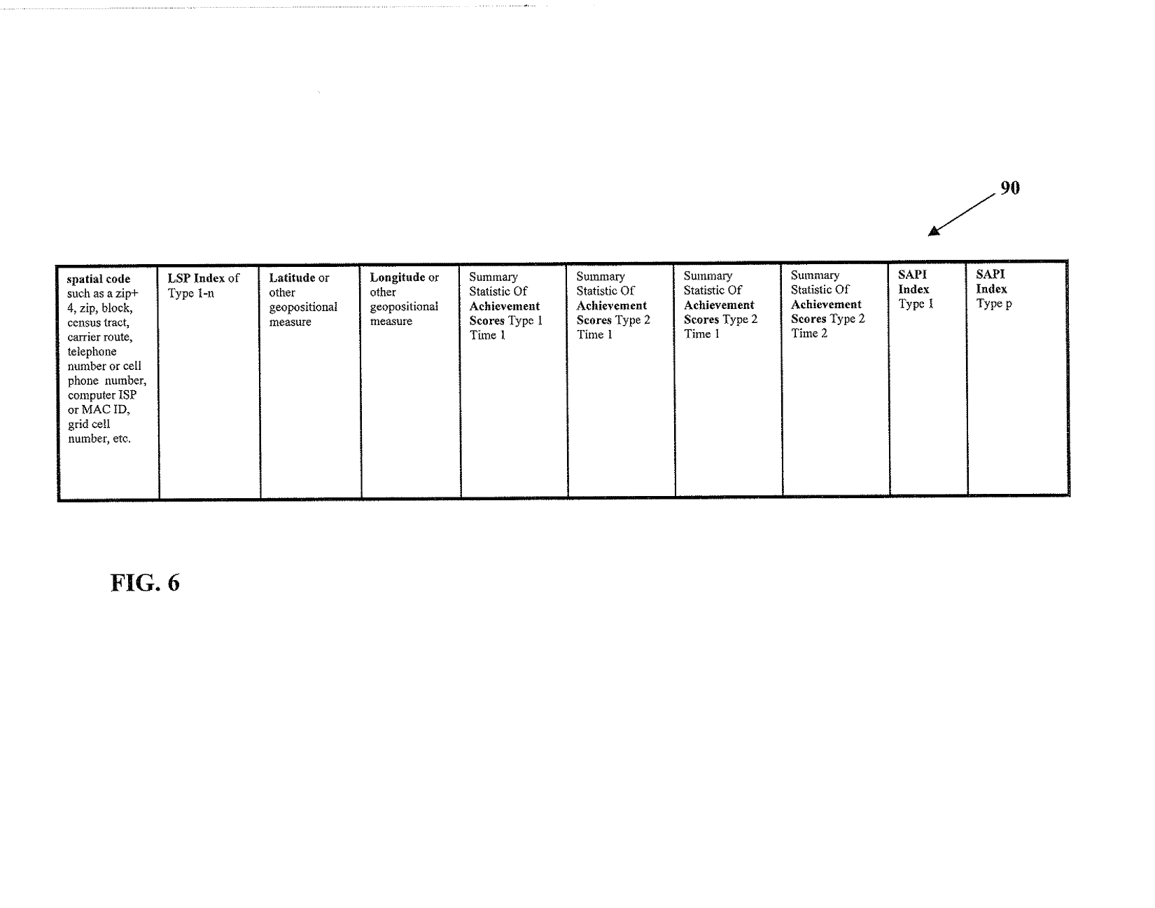

The Local Summary File 90 of FIG. 6 contains the resulting ranked LSP groups assigned one of the academic performance indicators such as the SAPI. Those groups performing statistically the same are assigned the same SAPI. The Local Summary File 90 can be maintained by the local school district or other organization. The Local Master File 85 is preprocessed by accessing software or online services that geocode and assign LSPs. The Local Summary File 90 can be created online and maintained by a local school district or other organization. The online service would access the preprocessed Local Master File 85, apply the appropriate reduction criteria, assign SAPI indexes back to the Local Master File, and create the Local Summary File 90.

If the geographic location for assigning LSPs is the ZIP+4, which is preferred and is the case with most commercial LSP products, then the ZIP+4 will have an associated SAPI. However, other LSPs can be utilized that are assigned other geographies, and might be independent of geography.

Commercial LSP products such as ESRI's® Tapestry™ product may have 64 or more LSP groups, which may be reduced to fewer statistically significant groups for convenience in some embodiments. Moreover, it is only an expedient cost effective procedure to use commercial available LSP data. It is not necessary to do so. LSP data can be calculated using known procedures and readily available databases. The use of the procedures set forth herein by commercial vendors can make their products cost effective and useful to education service providers, for example. Moreover, following calibration procedures as outlined for the Reduction Process, the SAPI can be input into the Reduction Procedure with a unique LSP index being assigned to the Local Master File 85. This LSP is education performance based.

For most ZIP+4 postal codes there will be an LSP associated therewith, and the various LSP measurement systems and groups can be assigned a SAPI index, then for ZIP+4 there can be an assigned SAPI. The Local Summary File 90 preferably contains fields for ZIP+4, SAPI indexes, and geographic coordinates such as latitude and longitude although different fields may be used in different embodiments.

GIS software may be used to map the SAPI indexes. Geographically Weighted Regression, other spatial statistical procedures and contour maps can be used to spatially interpolate and forecast expected values within areas missing data, and project those values into the future based upon historical changes in SAPI index. Groups of ZIP+4 performing with the same SAPI index can be combined to form a scholastic neighborhood. A GIS overlay of school district and scholastic neighborhood may or may not exactly overlap. Such maps are valuable to parents, education management, and real estate. Such maps are also valuable to educational marketing services.

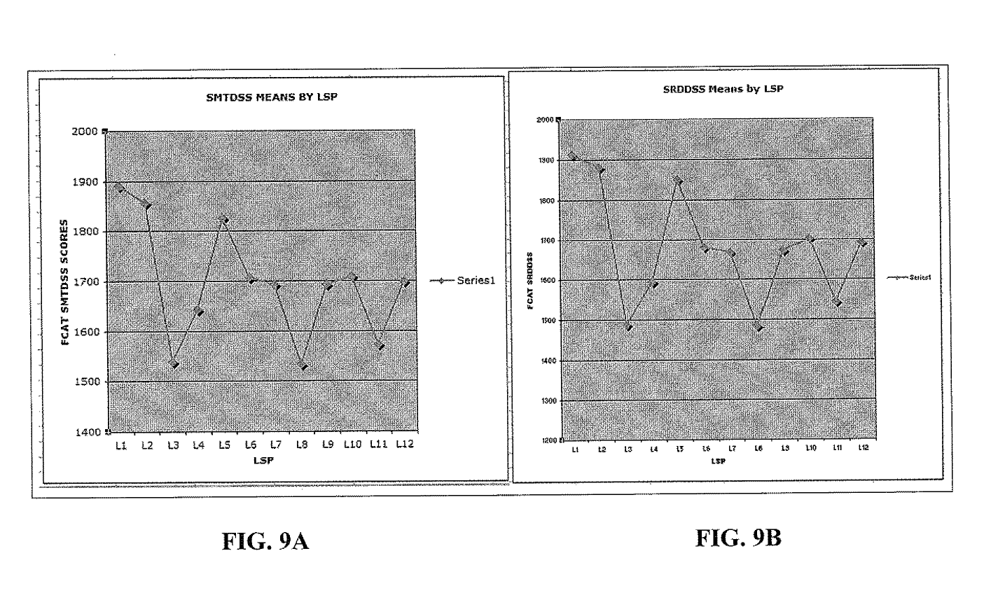

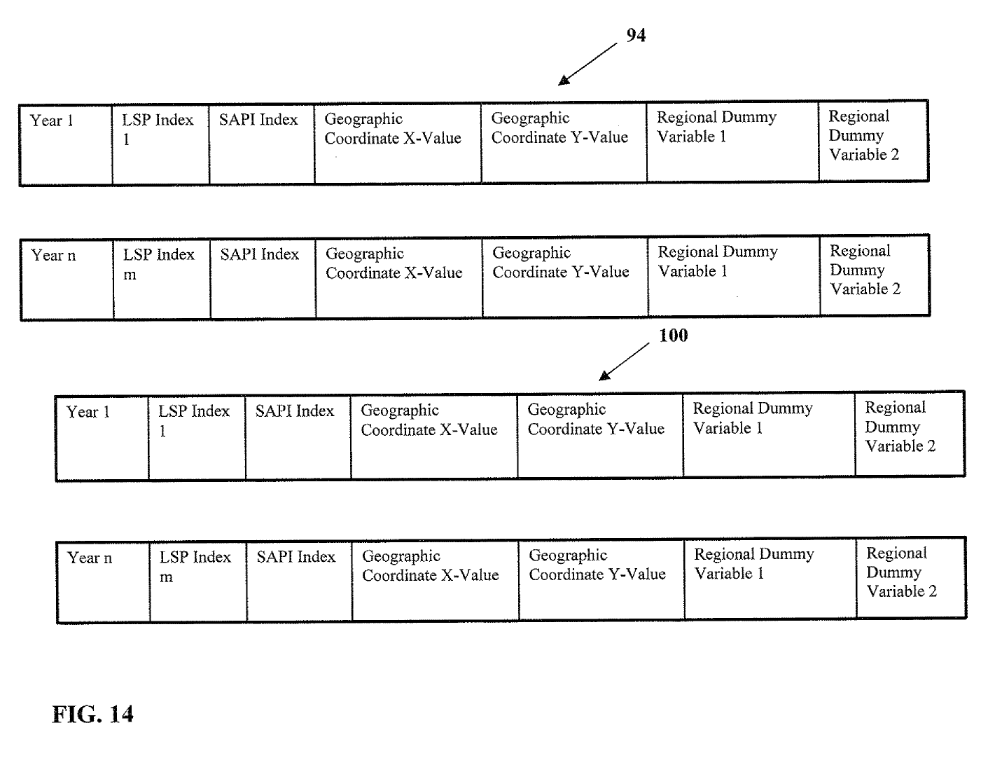

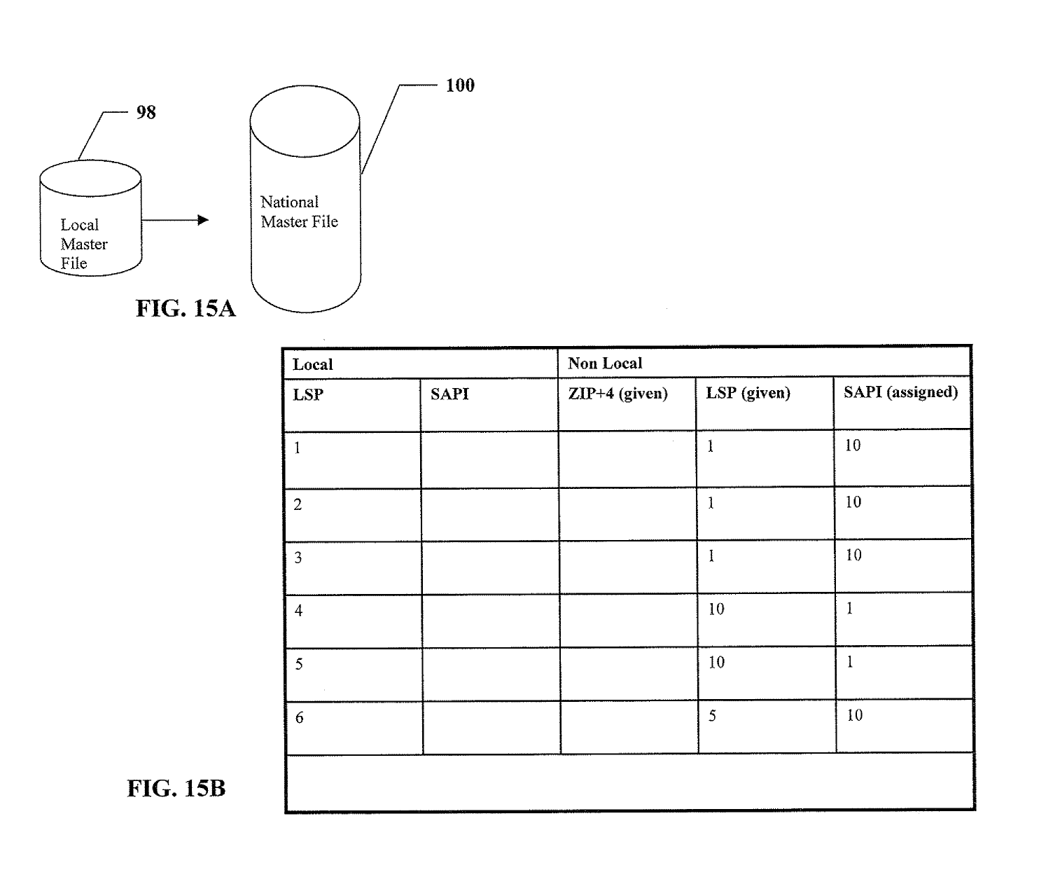

The Wide Area Summary File 92 in FIG. 9 is created using a procedure very similar to the procedure used to create the Local Summary File 90, but by pooling all available student data from a wide area, which can include multiple school districts. The Wide Area Summary File 82 may contain data for the entire United States, a larger area containing records for more than one country or for an area smaller than the entire United States (region, state, etc.). Enhancements to bring an additional level of accuracy are to add a regional identifier to the SAPI generation procedure and thereby calculate regionally specific SAPI indexes, as well as other location specific demographic and geographic data. Reversing the direction of the procedure of FIG. 9, a SAPI index once calibrated can be inserted within a modified Local Master File 94 or modified National Master File 96 of FIG. 14 based upon the ZIP+4, LSP or location code. The relationship between the Local Master File 94 and National Master File 96 is also illustrated in FIG. 15A with a sample database layout for the two files in FIG. 15B.

One exemplary implementation of the present invention is based upon data from Alachua County, Florida using the county's database of student home addresses and FCAT scores. In the example, it was demonstrated that student FCAT scores in Alachua County Florida were statistically significantly correlated to students' social status as measured by LSP.

While FCAT is used in the following description, other standardized tests that create past academic performance data may also be used, as will be appreciated by those skilled in the art. For example the State of California administers the California Achievement Battery. Scholastic achievement can be measured by national and international college entrance exams. National measures of scholastic achievement can be obtained from the National Assessment for Educational Progress (NAEP).

In the example, the student database was geocoded and individual student records were assigned LSP indexes. ESRI's® Community Coder™ was used for geocoding and for assignment of LSPs. The software package was able to assign 86 percent of the data records a latitude-longitude coordinate and a Tapestry™ LSP index. 24,229 records were included in the subsequent calculations. No patterns to unassigned data records other than 14 percent of student address records that had incomplete data entries were detected. Geocoding was restricted to street address or ZIP+4. The panel data also included the student's FCAT score.

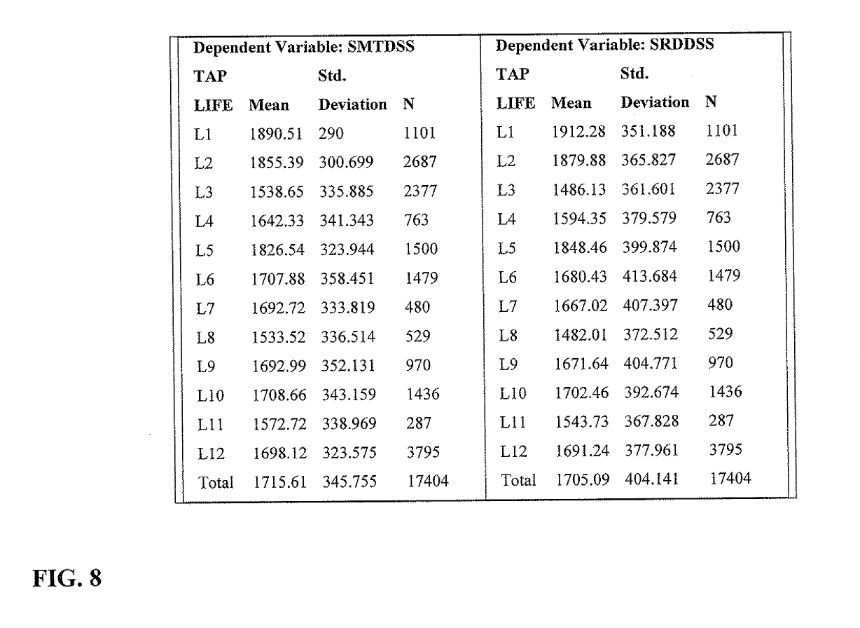

The average FCAT score for each of Tapestry's™ twelve LifeMode groups was then calculated. A Tapestry™ LifeMode group is a cluster of more detailed LSP segments, such as LifeMode L1 group is an agglomeration of Tapestry™ segments 1 through 7. The result is presented in FIG. 8. SMTDSS is the FCAT score for mathematics attainment. SRDDSS is the FCAT score for reading attainment.

The standardized test used in this example, the FCAT, is a criterion-referenced instrument. According to the Florida Department of Education (FDOE), the FCAT measures student achievement of the educational objectives identified in Florida's Sunshine State Standards in two content areas, reading and mathematics. The FCAT is designed to provide an objective measure of the Standards, and to provide feedback and accountability indicators to interested stakeholders, including students, their parents, educators, and policy makers. The FCAT is administered to all public school students in grades 3-10 on an annual basis. Students that do not achieve above minimum scores on FCAT are required to take the FCAT in grades 11 and 12. The test contains items that vary in terms of difficulty and cognitive complexity, which allows policy makers to establish a separate performance criterion for each grade level.

The results of the FCAT reading and FCAT mathematics tests are reported in three ways: as a scale score (SS) on a scale from 100-500 for each grade level; as a developmental scale score (DSS) on a scale of 0-3000 that extends across all grade levels; and as a measure of achievement level. Scale score ranges that have been calibrated to align with specific cut off points are used to identify achievement level. The present example focuses on the reading DSS and the mathematics DSS.

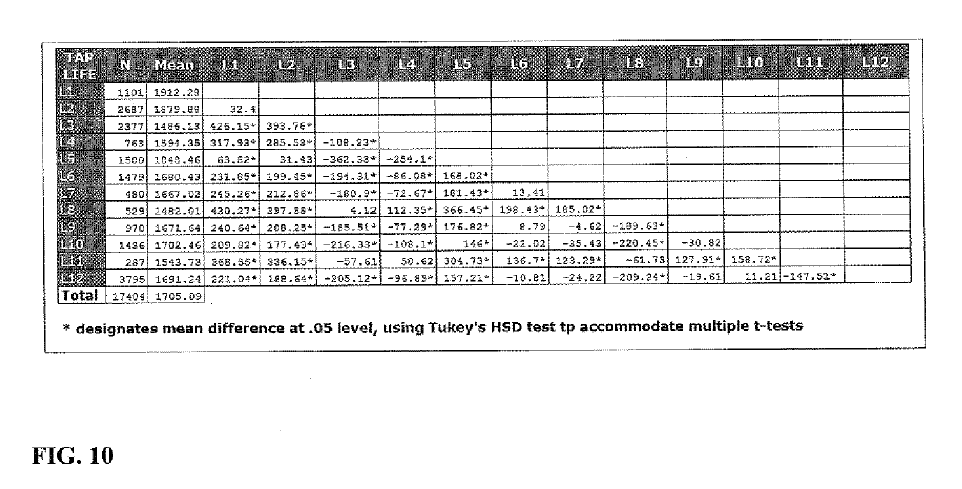

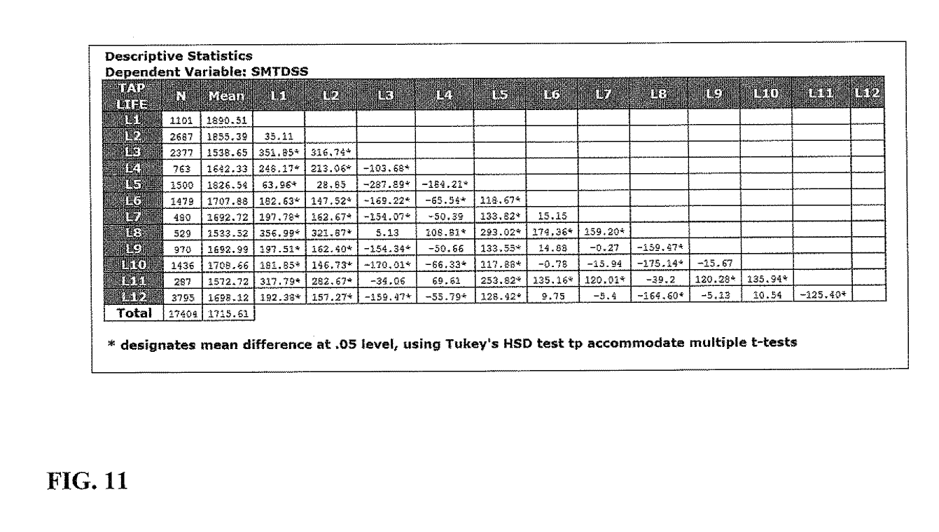

The DSS for the 2004 FCAT reading (SRDDSS) and FCAT mathematics (SMTDSS) tests for students in Alachua County were used. The means by LSP group are provided in column one of FIG. 8 and in the graph shown in FIGS. 9A and 9B respectively for SRDDSS and SMTDSS. Differences between the means of each LSP group were then calculated. The statistical significance of the mean differences were calculated using Tukey's HSD test. Differences that are significant at the 0.05 level are represented by an asterisk (*) in FIGS. 10 and 11.

The highest social status ESRI® Tapestry™ L1 also achieved the highest means on both reading and mathematics tests. In rank order, the lower social status LSP indexes were also characterized by lower mean test scores on both reading and mathematics. However, the second highest social status LSP group L2 was not statistically significantly different from L1, nor was LSP group L5. L5 is particularly interesting as L5 neighborhoods are characterized by the presence of older populations, giving rise to a “grandparent” hypothesis by which applicants theorize without wishing to be bound thereto that older populations provide benefits to younger populations regardless of social status. Such results can be used in assisting buyers/renters in their locational choice of where to buy or rent housing, for example. For instance, this information could be paired with a real estate location database such as MLS so that as buyers investigate houses in different neighborhoods, they can also be provided with SAPI information (or summaries thereof) to help select a desired location.

The other mean differences by LSP grouping were significantly different from L1. The implication is that educational achievement and performance as measured by means of standardized test scores increase as social status rises above the lowest measured by LSP, but increasing educational achievement and performance by social status increases between adjacent lower social status population groups, and then increases at a decreasing rate. As measured using standardized test scores, there is an advantage to being among the higher social status groups, but the advantage diminishes between adjacent social status groups as social status rises to the highest levels as measured by LSP.

In FIGS. 10 and 11 it may be seen that student FCAT scores in Alachua County Florida are statistically significantly correlated to students' social status as measured by LSP. The present approach provides a quantitative method to document that students' home environment as measured by location may be used for determining variation in student test achievement.

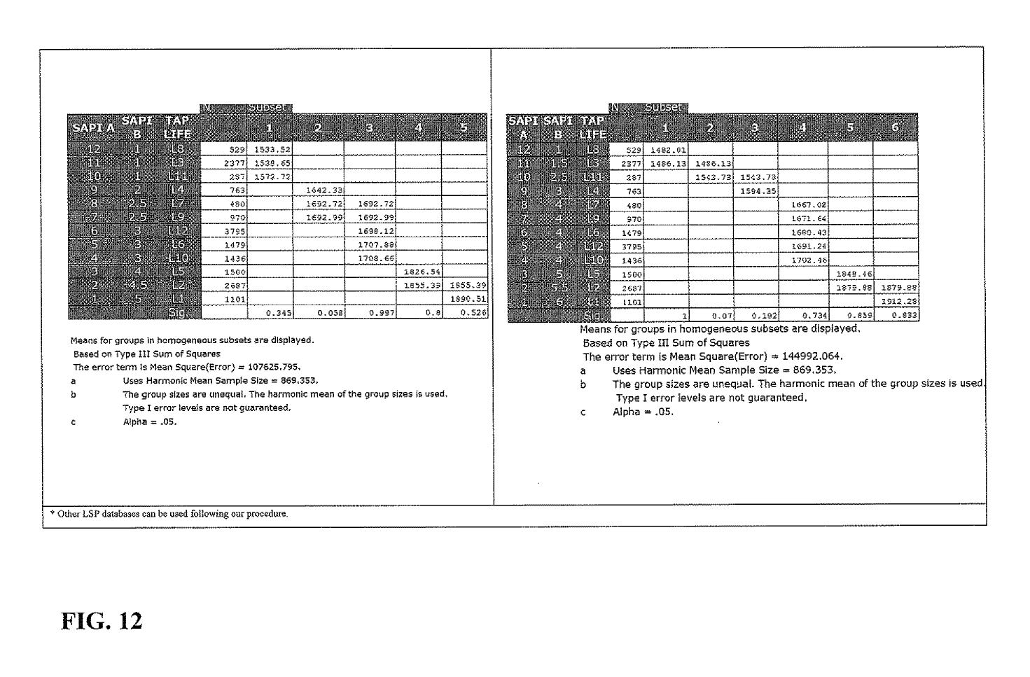

The past academic performance data used to generate academic performance indicators such as SAPI may be provided in a database table such as the Local Student File 81 of FIG. 5. The tables, fields and graphs of FIGS. 5-15 are provided for illustrative purposes, and other tables, fields and graphs could be utilized, as will be appreciated by those skilled in the art. The data could include the date of the test, test scores, and other personally identifying information including ID, name, and address. This Local Student File 81 can then be geocoded and assigned LSP indexes, geographic coordinates, ZIP+4, the result of which is shown in the Local Master File 85. SAPI or other academic performance indicators are calculated and assigned to appropriate records of data files, such as the Local Master File 85. The Local Summary File By Spatial Code or by LSP 90 is created following the method and procedure for calculation of SAPI from FIG. 11 and the above discussion. FIG. 12 provides an example of the Local Summary File 90 with data for the Alachua County example.

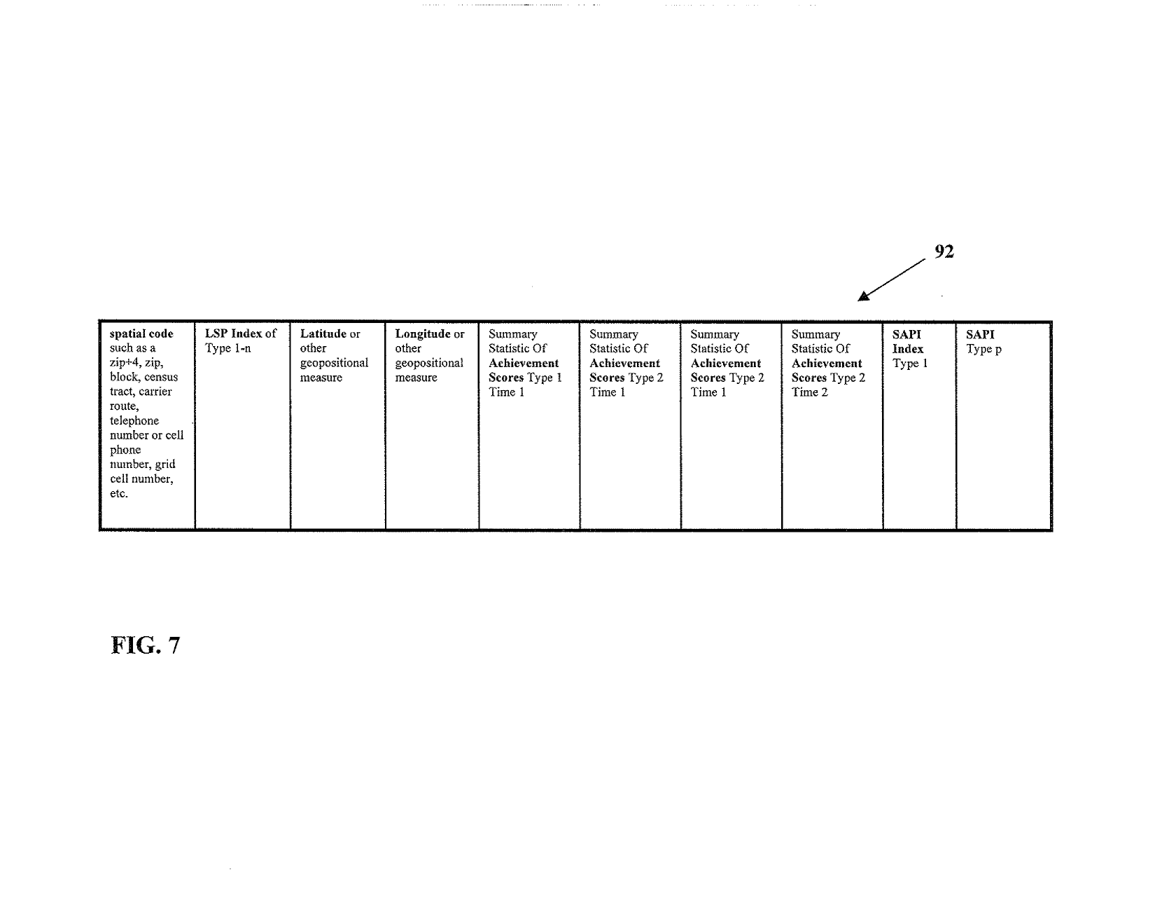

The Local Summary File By Spatial Code or by LSP 90 may have an academic performance indicator. In the present example, this includes a Scholastic Attainment Index (SAI) and a Scholastic Performance Index (SPI), together referred to as SAPI. Following the calculation of a statistically significant number of SAPI, those SAPI can be assigned with statistical confidence to ZIP+4 using LSP as the common RDBM key field, even if those ZIP+4s do not have results for scholastic attainment/performance tests. While it is preferred to use actual scholastic attainment/performance tests in the calculation of SAPI, this fallback procedure can be used to fill in the gap of information at the regional and national or wide area level (FIG. 7), and for the local level as well (FIG. 6). As the database of known scholastic attainment/performance test results becomes larger and known to analysts, the statistical confidence of projections of SAPI will increase, allowing information at the national level to be used to evaluate and update local files, and national files.

The correlation of LSP to measures of scholastic attainment and/or scholastic performance can differ statistically between regions. The algorithm for prediction of scholastic attainment and/or scholastic performance might have a different magnitude of correlation in one region versus another region. As shown in FIG. 14, the precision of statistical measurement can increase in such instances by the inclusion of dummy variables in the calibration of the modified Local Master File 94 and/or the modified National Master File 100 (e.g., with Di=1.0 if region i, 0.0 otherwise, for i=1 to n regions).

The body of each table of FIG. 12 includes expected achievement/performance scores of students grouped by LSP. The left table includes scores for SMTDSS and the right table includes SRDDSS. ESRI's® Tapestry™ is used to cluster students by psychographic profile, but other LSP databases can substitute for Tapestry™. Two expressions of SAPI are shown in the left two columns of each table of FIG. 12. “SAPI A” ranks expected achievement/performance from highest to lowest. “SAPI B” considers the statistically significant differentiation between adjacent performing LSP groups, and combines those where statistical evidence is insufficiently strong to support distinguishing the adjacent groups. For example, in the SRDDSS table of FIG. 12, LSP L5 is placed into groups 5 and 6, so is given a score of 5.5. Likewise, L11 is statistically placed in groups 2 and 3 and so is given a “SAPI B” rating of 2.5. While Tukey's honestly significant difference test (HSD) is used in FIG. 12, other statistically significant clustering algorithms may also be used, as will be appreciated by those skilled in the art. A summary reduction procedure that is geographically scalable upwards to the region, state, multi-region and nation is shown in FIG. 12. The Local Master File 85 can either be updated to include, for each student, the SAPI index as demonstrated in FIG. 12, dynamically linked to a database of LSP categories and SAPI indexes, or dynamically linked to a mathematical algorithm based upon a reduction procedure process to convert LSP categories to SAPI indexes.

FIG. 13 further summarizes the results of the example, and illustrates an algorithmic procedure. FIG. 13 is only for grade 3, in contrast to FIG. 12 which illustrated the creation of the SAPI index for an average across all grades. The algorithmic process is illustrated by answering the following questions. What grade level is the student? What type of test is of interest? If the answer is grade 3, and SMTSS (mathematics), the projection can be found in the table of FIG. 13. Else, proceed to the appropriate like kind table. What is the address of the student? Using a commercial product such as ESRI's Community Coder™, a psychographic LifeMode index is assigned to the street address and hence to the student resident at the address. If the student's LifeMode group is L4, the expected SMTDSS is 1292 with a 95 percent likelihood of the achieved score falling between 1242.574 and 1341.791.

Even if there is no address, households can still be assigned an LSP index. LSP indexes are measures of lifestyle and propensity to consume, and that has generally also been associated with consumption of housing and therefore choice of neighborhood, and consequently an address. However, databases such as those available from credit agencies including Equifax and Experian provide evidence of propensity to consume and therefore LSP. So LSP could be assigned by personal identification such as social security number in the United States, drivers license number, credit card number, cell phone number, telephone number, email address, computer ISP, or other personal identifier, for example.

The fallback procedure may be used to apply tables of average achievement by LSP for other neighboring geographic locations. The fallback reduction procedure is typically implemented in the event that either a location code or LSP code cannot be assigned. Missing or incorrect data for the neighboring geographic location is not required.

If a spatial code such as a ZIP+4 can be assigned, but a SAPI index cannot be assigned because an LSP index is not available for the particular spatial code, then a geographically weighted average of SAPI indexes nearby the neighboring location are used to estimate the SAPI. A flag index column may be added to the database, with the flag index reporting that a nearest neighbor procedure was used to calculate the SAPI, where nearer spatial codes with SAPI indexes are given more weight than distant spatial codes with SAPI indexes. In some embodiments, a weighted average is not required and the SAPI or other academic performance indicator for the neighboring location can be determined using a non-weighted average. The adjacent locations that are used in determining the SAPI may be identified using standard statistical techniques, as will be appreciated by those skilled in the art, or may be based on distance or other statistically significant polygon areas. The distance or polygon areas may be defined by the customer using the application.

Upon derivation of the SAPI index using the nearest neighbor procedure, the SAPI index is assigned to the spatial code such as a ZIP+4. Since LSP indexes are associated with SAPI codes, the resulting SAPI code can also be used to assign an LSP to the spatial code.

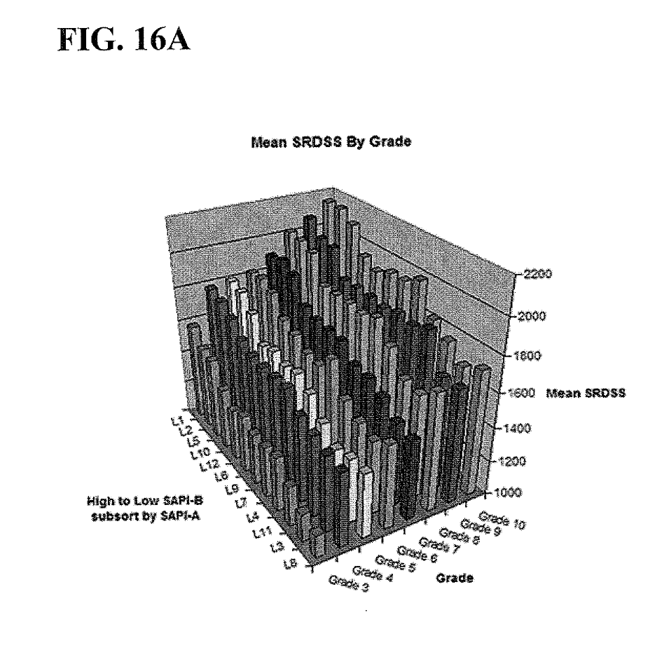

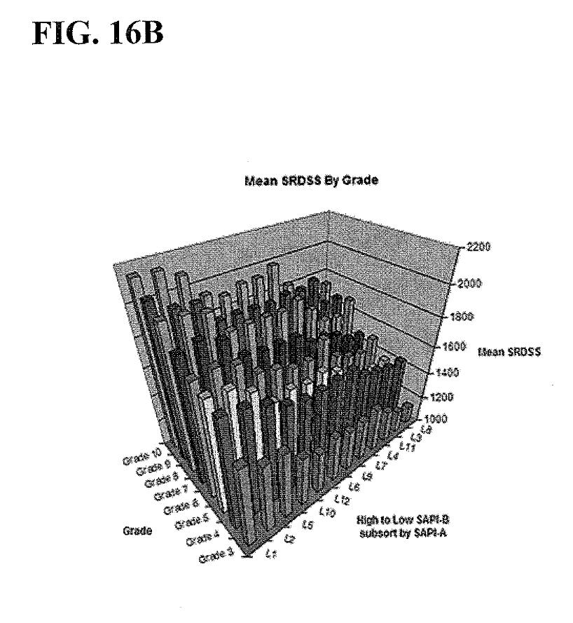

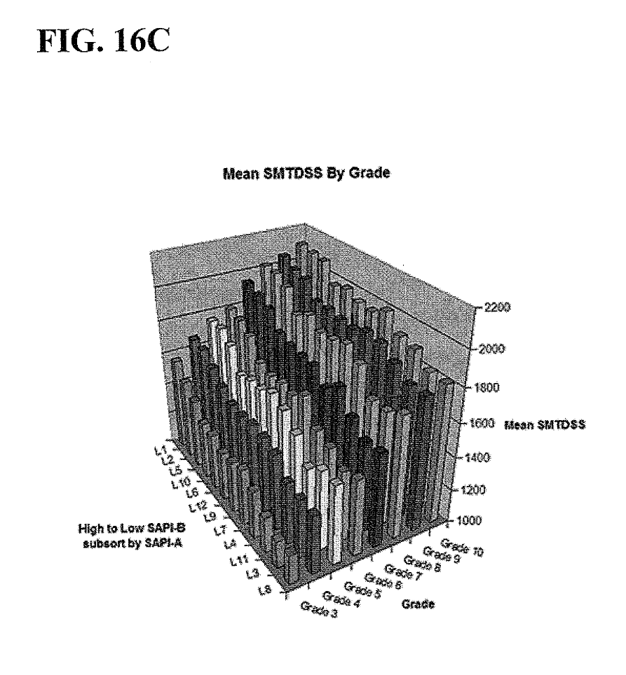

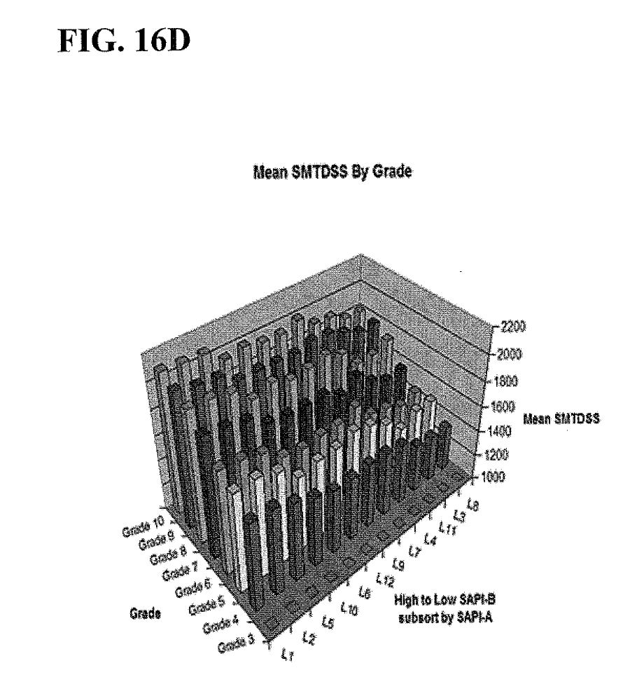

FIGS. 16A through 16D summarize the Alachua County data for reading and mathematics (SRDSS and SMTDSS). Two different 3D views are provided for each. The x-axis as displayed is grade level, ranging from 3 through 10. The y-axis as displayed is psychographic group, ESRI® Tapestry™ LifeMode groups L1 through L12 in this example, arrayed according to SAPI-B and where there are duplicate SAPI-B scores, further subordering by SAPI-A is performed. The z-axis as displayed is the average score achieved by the group, such as LifeMode group L5 for grade 7. The trend is clear by grade and SAPI in FIG. 16.

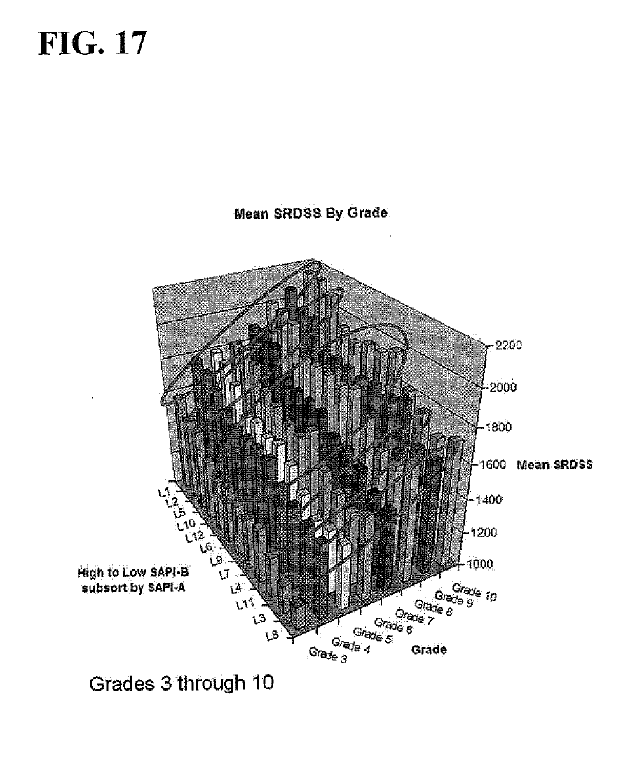

FIG. 17 is a visual illustration of the statistical calculation of SAPI. Groups are clustered together by SAPI-B and grade summary reports of the SAPI index include maps showing locations of the SAPI index values, maps showing spatial trends of the SAPI index, neighborhoods grouped together based upon same SAPI index, and maps of deviation between those SAPI indexes and actual category of individual student achievement. Grouping can be achieved using cluster analysis, geospatial statistical procedures including spatial autocorrelation and geographically weighted regression. Summary reports include expected performance of a school based upon student LSP composition and expected scores such as those in FIG. 12, versus actual aggregate school performance.

Spatial codes such as ZIP+4 usually have an assigned LSP, and the SAPI generation process described in FIG. 2 has associated a SAPI or other academic performance indicator to the LSP. Therefore, for spatial codes with a known LSP, there is a SAPI index. The SAPI generation procedure to generate a Local Summary File 90 is preferably performed using best available data, which is calculated as FIGS. 10 and 11 with local academic achievement scores. In the absence of local academic achievement scores, a fallback procedure is to apply tables of average achievement by LSP for other locations as in FIG. 12. A pooled data table may include student records from a wide geographic area, and calculated in the same manner but with the addition of pooled student records from a wider, perhaps even statewide or national geographic area. Standardized measures of local school performance are then calculated by comparing that school's SAPI measures to SAPI measures calculated using larger geographic areas.

Given a national table of spatial codes (ZIP+4) with corresponding LSP indexes for each spatial code, SAPI indexes can be scaled upward to the national level. The fallback procedure applies to the regional and national solutions table as well. In the event that a spatial code can be assigned, but a SAPI index cannot be assigned because an LSP index is not available for the particular spatial coder then a geographically weighted average of SAPI indexes nearby the spatial code location are used to estimate the SAPI. A flag index column is preferably added to the database, with the flag index reporting that a nearest neighbor procedure was used to calculate the SAPI, where nearer spatial codes with SAPI indexes are given more weight than distant spatial codes with SAPI indexes.

Where academic performance indicators are provided in an “online” environment where the SAPI or other academic performance indicator is requested in real timer the fallback procedure can become an exception handling algorithm to deal with requests for data that is either missing or incorrect. For example, when the database is queried with information relating to a student, a geographic location or an LSP, the database will provide the user with an academic performance indicator associated with the student geographic location or LSP. Where the requested information is missing, incorrect or out of date, exception handling is triggered and the calculation of SAPI can occur in real time to provide the requested information in response to the query.

A local master data file is created. Data fields may include students' and parents' names, addresses, spatial code such as a ZIP+4, various psychographic measurements, history of various types of achievement scores, geographic coordinates such as latitude longitude, and SAPI.

Summary reports of the SAPI or other academic performance indicators include maps showing locations of the SAPI index values, maps showing spatial trends of the SAPI index, neighborhoods grouped together based upon same SAPI index, and maps of deviation between those SAPI indexes and actual category of individual student achievement. Summary reports include expected performance of a school based upon student LSP composition and expected scholastic attainment scores, versus actual aggregate school performance. Summary reports may also be created using geostatistical evaluation such as point pattern analysis that can detect clustering, dispersal, random patterns, or ordered patterns. The Local Summary File 90 is scalable upwards to larger scales of geography, and downwards to smaller scales of geography.

In summary, the present invention advantageously provides a method for calculating expected scholastic attainment scores based on a geographic definition including postal geography, census geography, special grid coordinate geography, and custom geography. This allows for automatic and seamless identification of expected scholastic performance and achievement of people of different ages, actively enrolled or not in an educational setting. The system may be embodied in a geospatial procedure, digital electronic database files stored on a computer, files dynamically linked together and processed through mathematical algorithms to create summary academic performance indicator indexes that can be retrieved, transmitted, or further processed into reports. SAPI is an outcome of the mathematical algorithmic procedure. The SAPI is an indicator of prospective and actual educational achievement and performance. The SAPI can be used to identify appropriate educational materials to students best suited to those materials, can be used in the design of educational materials, and can be used in a variety of educational administrative frameworks, and can be used to assess characteristics of neighborhoods for commercial reasons.

Additional statistical and geospatial statistical procedures with SAPI include projections of generalizeable results to national and international locations, and for use in applications including evaluation of real estate and optimum location of real estate by type of real estate, and management of educational institutions and educational systems. These may include the development of and purchase of alternative curriculum models and instructional materials.

The system may utilize geographical position. Geographical positions can be input directly with any type of geographic projection and positional coordinate, including latitude longitude. Geographical position can be calculated using tables or geospatial technology including a global positioning system (GPS) or geographic information systems (GIS). Geographical position can be indirectly calculated using the complete U.S. (or other country) postal address, or subcomponents thereof, telephone number, telephone number Automatic Number Identification, cell phone transmittal information, name, computer ID such as a MAC address, similar addresses for personal digital assistants (PDAs), cell phones, or other identifier that may be used to generate an approximation for absolute or relative geopositioning.

Electronic digital files have a plurality of records having measures of scholastic achievement, a SAPI, geopositional information, and one or more spatial code fields, one or more of which may be frequently updated. The system may utilize an automated approach and receive input via a software program, including Internet software, personal computer, telephone, cell phone, or other electronic devices. This input may be processed by geographic location to generate an academic performance indicator for the geographic location. The geographic location may be identified using postal geography including a single address for a house, apartment, condominium or other single location. It may be identified by zip code such as a full zip code, zip+2, zip+3, zip+4, zip+6, etc, and may also be identified by neighborhood, city, region, county, parish, state, nation or other geographic locations. The geographic location may also be geographic indicators used by other countries such as the Canadian Postal Code or English postal code.

Automatic updating of files may be used to ensure that the academic performance indicators and other information remain accurate over time. Automatic updating could be accomplished by the following steps: automatically generating updated LSP tables comprising a plurality of records, each record including a spatial code and client information indicative of a geographic location, and each data record being assigned an LSP index based upon observed test achievement or other location specific geographic data. After assignment of LSP based on observed test achievement or other data, further processing such as the reduction procedure noted above may be performed automatically to finish the automated database processing.

The fallback procedure preferably begins using the Local Summary File by spatial code or LSP 90 and creating SAPI or other academic performance indicators for geographic locations where sufficient information is available for the location. The available SAPI data is then used in an expansion procedure to assign academic performance indicators to other geographic locations. Once other geographic locations are assigned academic performance indicators, the fallback procedure may be repeated with multiple passes through the process until all desired geographic locations have been assigned an academic performance indicator.

Accuracy of SAPI projection based upon LSP is improved by local school districts adopting the invention for the calculation of their local SAPI or other academic performance indicator projections. Software and databases may be made available either via the Internet or stand alone application for these calculations.

Academic performance indicators may be calculated for published and unpublished zip+4 codes and other geographic location identifiers, and psychographic indexes connected or not connected to geographic location, without any violation of federal, state and local laws is also provided. Moreover, assessment of schools, school districts, as well as for assessing individual student attainment, above or below that which would otherwise be expected may also be performed, as well as educational attainment and achievement by postal geography, census geography, special grid coordinate geography, and custom geography.

The systems and methods described above may be applied flexibly to accomplish one or more of the following objectives, as will be appreciated by those skilled in the art:
(1) identifying the expected educational performance of a student based upon that student's associated spatial code;
(2) identifying the expected educational performance of a student based upon psychographic (LSP) characteristics of the student which may or may not be geographically related;
(3) identifying the expected educational achievement of a student based upon that student's associated spatial code;
(4) identifying the expected educational achievement of a student based upon psychographic (LSP) characteristics of the student which are geographically related;
(5) identifying the expected educational achievement of a student based upon psychographic (LSP) characteristics of the student which are not geographically related;
(6) determining the spatial codes of the students;
(7) determining the psychographic (LSP) indexes of the students;
(8) identifying special educational needs of a student relative to a plurality of other students;
(9) finding a spatial code and retrieving spatial code dependent data, where: a location identified by the spatial code is assigned an LSP which has a logical or mathematical transformation to be a ranked SAPI; for locations which do not have spatial code dependent data, a nearest neighbor procedure for calculating the expected value of a location dependent data based upon the occurrence of location dependent data nearby for locations which do have spatial code dependent data and that are within a geographic area bounded by a predetermined polygon such as an attendance center/school district;
(10) for comparing expected level of scholastic achievement performance based upon psychographic characteristics and actual level of performance;
(11) for comparing expected level of scholastic achievement performance based upon attendance center/school district characteristics and actual level of performance;
(12) for using scholastic achievement indexes for the design of instructional and curricular materials;
(13) for redefining educational assessment;
(14) for projecting to regional and national levels expected scholastic achievement performance, and
(15) for improving forecasts of local, regional and national scholastic achievement performance indexes.

In some applications, a reduction in price for the software and databases may be provided if participating school districts make their summary databases available for data processing with the invention to better predict academic performance. Such data is preferably provided for processing in a form that does not jeopardize the privacy of the student and is allowed under federal and state law. This procedure allows more statistically accurate and regionally sensitive data to be generated and could be important for creating national SAPI tables. Regional tables shown to be statistically significantly different are designated with regional dummy variable flags and used for forecasting in those regions. Where regional tables do not show statistically significant differences, the flag may be absent or a separate flag could be used to identify those regions sharing similar or the same academic performance indicators.

The above-described approach advantageously provides educational achievement and performance benchmarks. The measurements can be applied to various applications, including the following:

Real Estate. The invention allows a decoupling of house selection from the simplistic inclusion within a school district. The invention can predict within a well performing school system those locations that if parents were to purchase will result in a high likelihood of lower achievement, and even within poorly performing school systems predict those locations which will result in higher than otherwise expected educational attainment. Educational attainment may be provided via a web site for individual addresses that is predicted with a statistical level of confidence.

Data. Data may be generated by companies presently making LSP data such as ESRI®, Experian®, Claritas® and MapInfo®. These databases could then be sold to intermediate or end users for use in their GIS applications. The data may provide SAPI projections by geographic code, such as ZIP+4 for the United States and other geographical indicators elsewhere in the world.

Software. Software may be implemented by companies and then sold to states, individual school districts or private schools for management and assessment, college entrance exams, as well as colleges and universities for use in admissions, for example.

Educational Material. The SAPI or other academic performance indicator could be used to select educational material for students. For example, students with a SAPI indicating lower levels of educational performance could receive educational material designed to their level of educational attainment. Material designed to these students could vary in difficulty to understand or could be focused on specific areas of educational problems for the given SAPI. Students with a SAPI associated with higher levels of educational attainment could receive educational material designed for higher levels of educational attainment. Educational material designed for these SAPI levels could be delivered in traditional paper form in school, through the mail or through other paper delivery means. This educational material may also be distributed through computer networks such as the Internet to computers or distributed through computers to portable media devices such as portable electronic music players and PDAs.

That which is claimed is:

1. An information processing method comprising:
providing past academic performance data for at least one student associated with at least one lifestyle segmentation profile (LSP), the past academic performance data comprising academic test score data; and
generating an academic performance indicator for the at least one LSP based upon the past academic performance data.

2. The method of claim 1 further comprising determining an LSP for at least one unprofiled student based upon past academic performance data for the at least one unprofiled student, the past academic performance data for the at least one student, and the at least one LSP associated with the at least one student.

3. The method of claim 1 further comprising determining an academic performance indicator for at least one unprofiled student based upon past academic performance data for the at least one unprofiled student and the past academic performance data for the at least one student.

4. The method of claim 1 wherein the at least one student comprises at least one first student; and further comprising determining an academic performance indicator for at least one second student having missing past academic performance data associated therewith based upon an LSP associated with the at least one second student, the at least one LSP associated with the at least one first student, and the academic performance indicator for the at least one first student.

5. The method of claim 1 wherein the at least one LSP comprises a plurality thereof; and further comprising grouping LSPs having academic performance indicators with insignificant statistical differences therebetween.

6. The method of claim 1 wherein the past academic performance data comprises standardized test score data.

7. The method of claim 1 wherein the past academic performance data further comprises student attendance rate data.

8. The method of claim 1 wherein the past academic performance data further comprises student truancy data.

9. The method of claim 1 wherein the past academic performance data further comprises student tardiness data.

10. The method of claim 1 wherein generating comprises generating the academic performance indicator based upon an average of the past academic performance data.

11. The method of claim 10 wherein the average comprises a mean.

12. An information system comprising:
a database for storing past academic performance data for at least one student associated with at least one lifestyle segmentation profile (LSP), the past academic performance data comprising academic test score data; and
a processor cooperating with said database for generating an academic performance indicator for the at least one LSP based upon the past academic performance data.

13. The system of claim 12 wherein said processor is also for determining an LSP for at least one unprofiled student based upon past academic performance data for the at least one unprofiled student, the past academic performance data for the at least one student, and the at least one LSP associated with the at least one student.

14. The system of claim 12 wherein said processor is also for determining an academic performance indicator for at least one unprofiled student based upon past academic performance data for the at least one unprofiled student and the past academic performance data for the at least one student.

15. The system of claim 12 wherein the at least one student comprises at least one first student; and wherein said processor is also for determining an academic performance indicator for at least one second student having missing past academic performance data associated therewith based upon an LSP associated with the at least one second student, the at least one LSP associated with the at least one first student, and the academic performance indicator for the at least one first student.

16. The system of claim 12 wherein the past academic performance data comprises standardized test score data.

17. A computer-readable medium having computer-executable instructions for causing a computer to perform steps comprising:
providing past academic performance data for at least one student associated with at least one lifestyle segmentation profile (LSP), the past academic performance data comprising academic test score data; and
generating an academic performance indicator for the at least one LSP based upon the past academic performance data.

18. The computer-readable medium of claim 17 wherein the computer-readable medium further has computer-executable instructions for causing the computer to perform a step comprising determining an LSP for at least one unprofiled student based upon past academic performance data for the at least one unprofiled student, the past academic performance data for the at least one student, and the at least one LSP associated with the at least one student.

19. The computer-readable medium of claim 17 wherein the computer-readable medium further has computer-executable instructions for causing the computer to perform a step comprising determining an academic performance indicator for at least one unprofiled student based upon past academic performance data for the at least one unprofiled student and the past academic performance data for the at least one student.

20. The computer-readable medium of claim 17 wherein the at least one student comprises at least one first student; and wherein the computer-readable medium further has computer-executable instructions for causing the computer to perform a step comprising determining an academic performance indicator for at least one second student having missing past academic performance data associated therewith based upon at least one LSP associated with the at least one second student, the at least one LSP associated with the at least one first student, and the academic performance indicator for the at least one first student.

21. The computer-readable medium of claim 17 wherein the at least one LSP comprises a plurality thereof; and further comprising grouping LSPs having academic performance indicators with insignificant statistical differences therebetween.
